(19) United States
(12) Patent Application Publication
(10) Pub. No.: US 2015/0324348 A1
(43) Pub. Date: Nov. 12, 2015

(54) ASSOCIATING AN IMAGE THAT CORRESPONDS TO A MOOD

(71) Applicant: LENOVO (Singapore) PTE, LTD., New Tech Park (SG)

(72) Inventors: Nathan J. Peterson, Durham, NC (US); John Carl Mese, Cary, NC (US); Russell Speight VanBlon, Raleigh, NC (US); Arnold S. Weksler, Raleigh, NC (US)

(73) Assignee: LENOVO (Singapore) PTE, LTD., New Tech Park (SG)

(21) Appl. No.: 14/274,325

(22) Filed: May 9, 2014

(51) Int. Cl. G06F 17/27; G10L 25/48

(52) U.S. Cl. CPC G06F 17/2765; G10L 25/48

(57) ABSTRACT

For associating an image that corresponds to a mood, code identifies the mood of a digital message. The code further associates the image that corresponds to the mood to the digital message.

### FIELD

The subject matter disclosed herein relates to images and more particularly relates to associating an image that corresponds to a mood.

### BACKGROUND

### Description of the Related Art

Images are often automatically added to digital messages. The images may be of the sender or otherwise representative of the sender.

### BRIEF SUMMARY

An apparatus for associating an image that corresponds to a mood is disclosed. The apparatus includes an electronic device that includes a processor and a memory that stores code executable by the processor. The code identifies the mood of a digital message. The code further associates the image that corresponds to the mood to the digital message. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a messaging system;

FIG. 2A is a schematic block diagram illustrating one embodiment of mood criteria;

FIG. 2B is a schematic block diagram illustrating one embodiment of mood data;

FIG. 2C is a schematic block diagram illustrating one embodiment of a mood image database;

FIG. 3 is a schematic block diagram illustrating one embodiment of a computer;

FIG. 4A is a schematic flow chart diagram illustrating one embodiment of an image association method;

FIG. 4B is a schematic flow chart diagram illustrating one embodiment of a mood identification method;

FIG. 4C is a schematic flow chart diagram illustrating one embodiment of a context identification method; and

FIG. 5 is a front view drawing illustrating one embodiment of a target electronic device displaying a digital message.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages, including an object oriented programming language such as Java, Smalltalk, C++ or the like and conventional procedural programming languages, such as the “C” programming language or similar programming languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

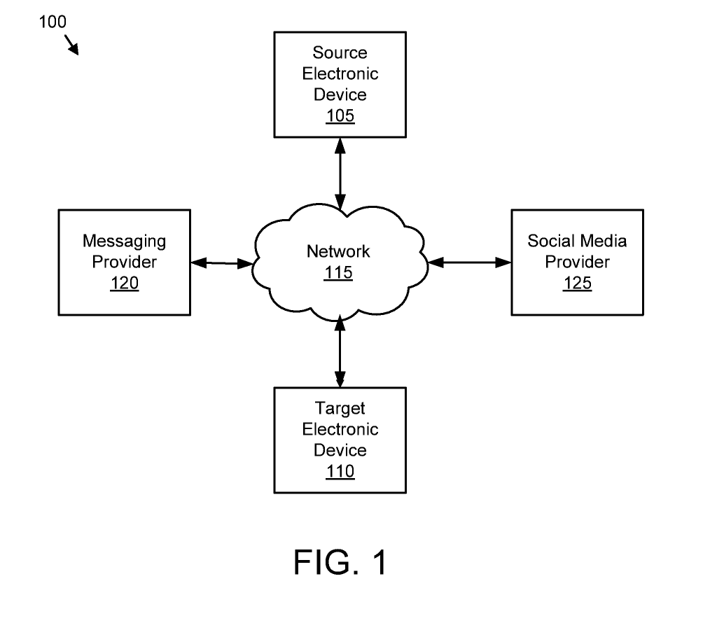

FIG. 1 is a schematic block diagram illustrating one embodiment of a messaging system 100. The system 100 may transmit a digital message. In the depicted embodiment, the system 100 includes a source electronic device 105, a target electronic device 110, a network 115, a messaging provider 120, and a social media provider 125. The system 100 may transmit a digital message from the source electronic device 105 to the target electronic device 110.

The network 115 may be the Internet, a mobile telephone network, a wide-area network, a local area network, a wireless network, or combinations thereof. The source electronic device 105 may generate the digital message. The messaging provider 120 may be an email provider, an instant messaging provider, a short messaging service (SMS) provider, or the like. The messaging provider 120 may receive the digital message generated by the source electronic device 105 over the network 115. The messaging provider 120 may further route the digital message over the network 115 to the target electronic device 110.

In one embodiment, the source electronic device 105 and/or the messaging provider 120 may associate an image to the digital message. The image may be of the sender who is using the source electronic device 105. Alternatively, the image may be otherwise representative of the sender. For example, the image may be of the sender's favorite sports team, an image associated with the sender's hobby, or the like.

In one embodiment, the source electronic device 105 and/or the messaging provider 120 may retrieve the image from a social media account of the sender maintained by the social media provider 125. The same image may be used for all digital messages generated by the source electronic device 105 and/or routed by the messaging provider 120.

Unfortunately, when a single image is always used to represent the sender, that image may not always reflect the mood of the sender and/or the context of the digital message. For example, an image showing the sender in a happy, playful situation may be inappropriate for a digital message that expresses sympathy or condolences.

The embodiments described herein identify the mood of the digital message. In addition, the embodiments associate an image that corresponds to the mood to the digital message. As a result, the image matches the mood of the digital message without the sender manually selecting an appropriate image.

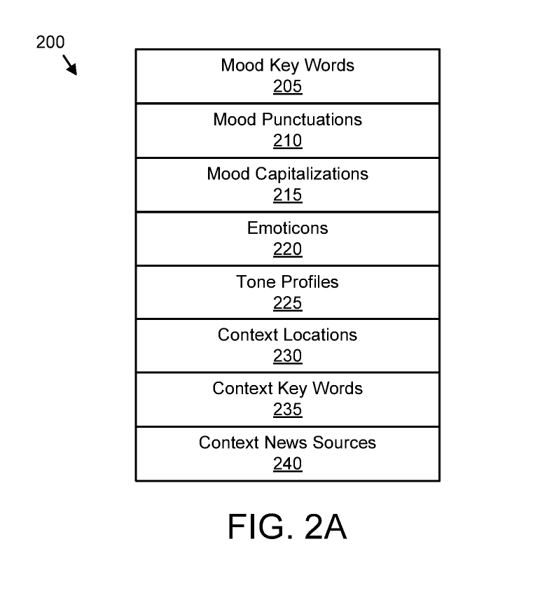

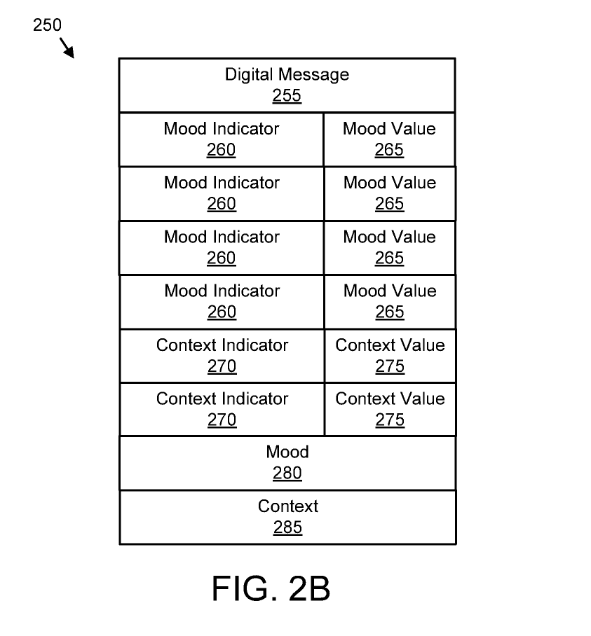

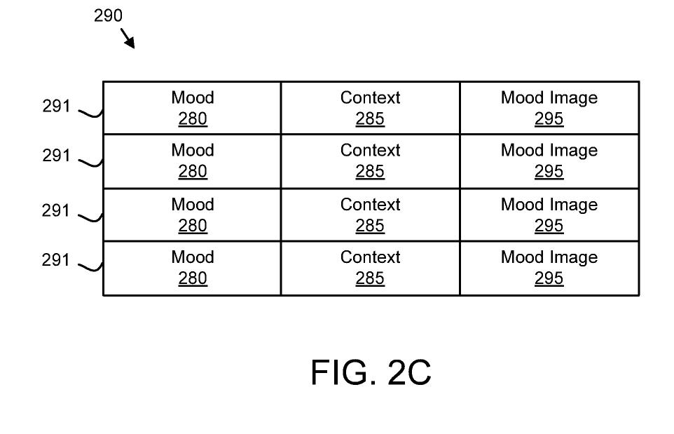

FIG. 2A is a schematic block diagram illustrating one embodiment of mood criteria 200. The mood criteria 200 may be organized in a data structure. In one embodiment, the mood criteria 200 are organized as an entry in a database indexed to the sender and/or the source electronic device 105. The mood criteria 200 may be stored in a memory of the source electronic device 105, the messaging provider 120, or combinations thereof. In the depicted embodiment, the mood criteria 200 includes mood key words 205, mood punctuations 210, mood capitalizations 215, emoticons 220, tone profiles 225, context locations 230, context key words 235, and context news sources 240.

The mood key words 205 may comprise a list of key words associated with one or more moods. Each mood key word 205 may be a mood indicator. In addition each mood key word 205 may be associated with the mood value. The mood value may be indicative of a type of mood.

The mood punctuations 210 may comprise a list of punctuations that indicate mood. Each mood punctuation 210 may be a mood indicator. A mood value may be associated with each mood punctuation 210. For example, an exclamation mark may be a mood indicator associated with a mood value of a positive mood.

The mood capitalizations 215 may identify capitalizations that are used to convey mood. In one embodiment, the mood capitalizations 215 may identify mood key words 205. In addition, the mood capitalizations 215 may increase the mood value of the identified mood key word 205.

The emoticons 220 comprise a list of emoticons and mood values associated with the emoticons. Each emoticon 220 may be a mood indicator. For example, a smiling emoticon mood indicator may be associated with a positive mood value.

The tone profiles 225 may profile the frequency ranges, cadences, inflections, and the like of the sender speech as mood indicators, with mood values associated with each mood indicator. For example, lower frequency, higher intensity speech may be mood indicators associated with an anger mood value.

The context locations 230 may comprise one or more locations that are context indicators. The locations may be global positioning system (GPS) coordinates, addresses, and the like. Each context location 230 may have an associated mood value. In one embodiment, the context values for the context locations 230 are determined by analyzing past digital messages from a location and calculating a mood for the location. The calculated mood may be used to calculate the context value for the context location 230.

The context key words 235 may comprise a list of key words that indicate context. For example, the key word “marketing” may indicate a professional context. Each context key word 235 is associated with the context value. In one embodiment, the context values for the context key words 235 are determined by analyzing past digital messages with the particular context key word 235 and calculating a mood for the context key word 235. The calculated mood may be used to calculate the context value for the context key word 235.

The context news sources 240 may record news articles, social media post, and the like, referred to herein as news sources, that were received by the sender at the source electronic device 105. In one embodiment, context values are calculated for each of the context news sources 240. The context values 275 for recently received context new sources 240 may be used to identify the context of the digital message.

FIG. 2B is a schematic block diagram illustrating one embodiment of mood data 250. The mood data 200 maybe organized as a data structure. The mood data 200 may reside on the source electronic device 105, the messaging provider 120, or combinations thereof. In the depicted embodiment, the mood data 200 includes the digital message 255, one or more mood indicators 260 with associated mood values 265, one or more context indicators 270 with associated context values 275, a mood 280, and a context 285.

The digital message 255 may store and/or reference the complete digital message 255 generated by the source electronic device 105. Each mood indicator 260 may be a mood key word 205, a mood punctuation 210, a mood capitalization 215, and emoticon 220, and/or tone profiles 225 from the digital message 255. The mood value 265 for each mood indicator 260 may be calculated using the mood criteria 200.

In one embodiment, each mood value 265 is a vector for a multidimensional mood space. The mood space may have a dimension for each of a plurality of moods. In one embodiment, a mood value 265 may include a value for each dimension of the mood space.

Each context indicator 270 may be a context location 230, a context key word 235, and/or a context news source 240 of the digital message 255. For example, the context location 230 may be determined from the network location of the source electronic device 105, a GPS coordinate of the source electronic device 105, or the like. The context value 275 for each context indicator 270 may be calculated using the mood criteria 200.

The mood 280 is the calculated mood for the digital message 255. The mood 280 may be calculated from the mood values 265 for mood indicators 260 in the digital message 255 as will be described hereafter. The context 285 is the calculated context for the digital message 255. The context 285 may be calculated from the context values 275 for context indicators 270 in the digital message 255 as will be described hereafter.

FIG. 2C is a schematic block diagram illustrating one embodiment of mood image database 290. The mood image database 290 may be organized as a data structure. The mood image database 290 may reside on the source electronic device 105, the messaging provider 120, or combinations thereof.

The mood image database 290 includes entries 291 for a plurality of moods 280 and/or contexts 285. Each entry 291 is associated with a mood image 295. In addition, each entry 291 may include a mood 280, a context of 285, or combinations thereof. The mood 280 and/or context 285 of a digital message 255 may be used as an index to identify a corresponding mood 280/context 285 combination in a mood image database 290. In one embodiment, the mood image 295 corresponding to an identified mood 280 may be associated with the digital image 255 when the digital image 255 is communicated to the target electronic device 110.

In one embodiment, the mood images 295 are selected by the sender for each of the moods 280 and/or contexts 285. Alternatively, the mood images 295 may be selected by analyzing the sender's social media account at the social media provider 125. Code may identify images of the sender and identify a mood 280 and/or context 285 from posts associated with each of the images. Images that are strongly indicative of a particular mood 280 and/or context 285 may be added to the mood image database 290 and associated with that mood 280 and/or context 285. In one embodiment, the sender may approve or reject each mood image 295 before that mood image 295 is automatically added to the mood image database 290.

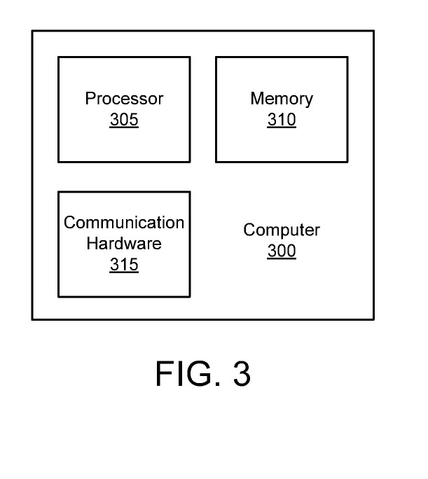

FIG. 3 is a schematic block diagram illustrating one embodiment of a computer 300. The computer 300 may be embodied in the source electronic device 105, the target electronic device 110, the messaging provider 120, and/or the social media provider 125. The computer 300 includes a processor 305, a memory 310, and communication hardware 315. The memory 310 may be a semiconductor storage device, a hard disk drive, an optical storage device, a micromechanical storage device, or combinations thereof. The memory 310 may store code. The processor 305 may execute the code. The communication hardware 315 may communicate with the network 115 and other devices.

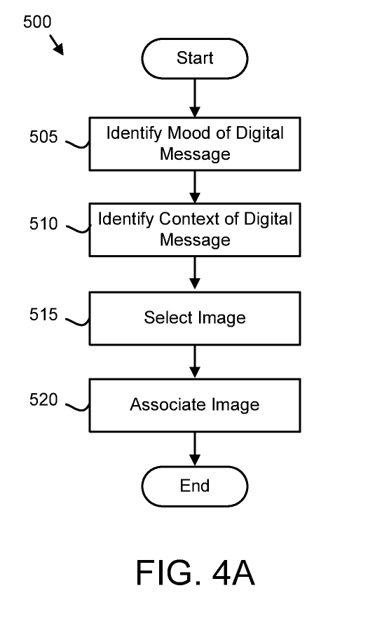

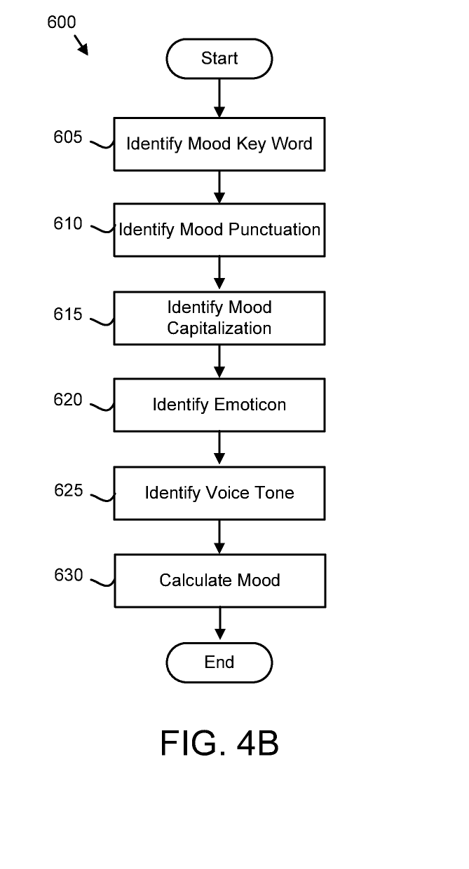

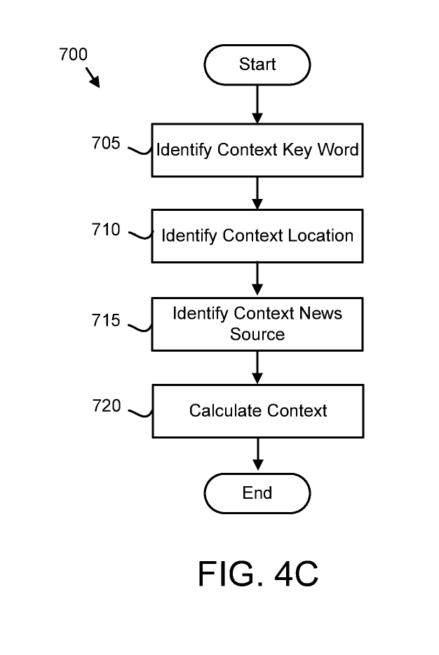

FIG. 4A is a schematic flow chart diagram illustrating one embodiment of an image association method 500. The method 500 identifies a mood 280 of the digital message 255 and associates a mood image 295 that corresponds to the mood 280 to the digital message 255. The method 500 may be performed by the processor 305. Alternatively, the method 500 may be performed by a computer readable storage medium such as the memory 310. The memory 310 may store code that is executed by the processor 305 to perform the method 500.

The method 500 starts, and in one embodiment, the code identifies 505 the mood 280 of a digital message 255. The digital message 255 may be communicated from the source electronic device 105 to the target electronic device 110. Alternatively, the digital message 255 may be communicated from the source electronic device 105 to the messaging provider 120. The messaging provider 120 may process the digital message 255 and communicate the digital message 255 to the target electronic device 110.

The mood 280 may be identified 505 in response to a mood indicator 260 selected from the group consisting of a mood key word 205, a mood punctuation 210, a mood capitalization 215, and an emoticon 220. Alternatively, the mood 280 may be identified 505 from a voice tone of the message 255 by comparing the voice tone with the tone profiles 225. The identification 505 of the mood 280 will be described in more detail in FIG. 4B.

The code may further identify 510 the context 285 of the digital message 255. The context 285 may be identified 510 in response to a context indicator 270 selected from the group consisting of a context key word 235, a context location 230, and a context news source 240. The identification 510 of the context 285 will be described in more detail in FIG. 4C.

In one embodiment, the code selects 515 an image that corresponds to the mood 280. In one embodiment, the image is the mood image 295 associated with the mood 280 of the digital message 255 in the mood image database 290. In a certain embodiment, the image is selected in response to one of the mood 280 and the context 285. Alternatively, the image may be selected 515 in response to the context 285.

The code may further associate 520 the image that corresponds to the mood 280 and/or context 285 to the digital message 255 and the method 500 ends. In one embodiment, the mood image 295 is associated with the digital message 255 by an association selected from the group consisting of appending the image 295 to the digital message 255, appending a pointer to the image 295 to the digital message 255, and designating the image 295 as a message account image for a display time interval.

For example, the mood image 295 may be appended as an attachment to the digital message 255. Alternatively, a pointer to the image 295 may be appended as embedded within the digital message 255. In a certain embodiment, the code may modify the message account image of the sender's social media account at the social media provider 125 to be the mood image 295. The message account image may be modified for a display time interval. In one embodiment, the display time interval is a time required to send the digital message 255. During the display time interval, the source electronic device 105 and/or the messaging provider 120 may retrieve the message account image from the social media provider 125 and append the message account image to the digital message 255.

FIG. 4B is a schematic flow chart diagram illustrating one embodiment of a mood identification method 600. The method 600 may identify the mood 280 of the digital message 255. The method 600 may perform the identify mood step 505 of FIG. 4A. The method 600 may be performed by the processor 305. Alternatively, the method 600 may be performed by a computer readable storage medium such as the memory 310. The computer readable storage medium may store code that is executed by the processor 305 to perform the method 600.

The method 600 starts, and in one embodiment, the code identifies 605 the mood key words 205 from the digital message 255. The code may scan the digital message 255 for key words corresponding to the mood key words 205 and store each mood key word 205 that is found in the digital message 255 as a mood indicator 260 in the mood data 250. In addition, the code may append the mood value 265 associated with the mood key words 205 of the mood criteria 200 to the mood data 250.

The code may further identify 610 the mood punctuation 210 from the digital message 255. The code may scan the digital message 255 for mood punctuations 210 and store each mood punctuation 210 as a mood indicator 260 in the mood data 250. In addition, the code may append the mood value 265 associated with the mood punctuation 210 of the mood criteria 200 to the mood data 250.

In one embodiment, the code identifies 615 a mood capitalization 215 of the digital message 255. The code may scan the digital message 255 using the mood capitalizations 215 and identify capitalizations that are used to express emotion. The code may further append the mood indicator 260 for a mood keyword 205 associated with the mood capitalizations 215 to the mood data 250. In addition, the code may append the mood value 265 associated with the mood keyword 205 to the mood data 250, with the mood value 265 modified by the mood value 265 of the mood capitalization 215.

The code may identify 620 an emoticon 220 of the digital message 255. For example, the code may scan the message 255, identify an emoticon 220, append the emoticon 220 as a mood indicator 260 in the mood data 250, and append the mood value 265 associated with the emoticon 220 to the mood data 250.

In one embodiment, the code identifies 625 a voice tone of the digital message 255 by comparing an audio of the digital message 255 with the tone profiles 225. The code may identify a portion of the audio that includes the sender's voice. The code may further compare the frequency ranges, cadences, inflections of the sender's voice to the tone profiles 255 and identify mood indicators 260 that are appended to the mood data 250 along with the corresponding mood values 265 for the mood indicators 260.

The code may calculate 630 the mood 280 for the digital message 255 and the method 600 ends. In one embodiment, the code calculates 630 the mood 280 from the mood values 265 stored in the mood data 250. For example, the code may sum mood vectors of the mood values 265. The mood dimension of the resulting vector sum with the greatest value may be selected as the mood 280.

FIG. 4C is a schematic flow chart diagram illustrating one embodiment of a context identification method 700. The method 700 may identify the context 285 of the digital message 255. In one embodiment, the method 700 performs the identify context step 510 of FIG. 4A. The method 700 may be performed by the processor 305. Alternatively, the method 700 may be performed by a computer readable storage medium such as the memory 310. The memory 310 may store code that is executed by the processor 305 to perform the method 700.

The method 700 starts, and in one embodiment, the code identifies 705 a context key word 235 for the digital message 255. The code may scan the digital message 255 to identify 705 key words in the digital message 255 corresponding to the context key words 235. The code may further append the context indicator 270 for the identified context key word 235 to the mood data 250 and append the context value 275 associated with the context indicator 270 to the mood data 250.

The code may further identify 710 a context location 230 of the digital message 255. In one embodiment, the context location 230 is identified from the GPS coordinates of the source electronic device 105. Alternatively, the context location 230 is identified from the network access point of the network 115 used by the source electronic device 105. The code may append a context indicator 270 for the context location 230 to the mood data 250. In addition, the code may append the context value 275 corresponding to the context indicator 270 to the mood data 250.

In one embodiment, the code identifies 715 the context news source 240 associated with the digital message 255. The code may scan the context news sources 240 that were received by the sender at the source electronic device 105 within a context time interval. The context time interval may be in the range of 0 to 5 minutes. The context indicator 270 for the context news source 240 may be a most frequently used noun in the context news source 240. The code may append the context indicator 270 to the mood data 250. The context value 275 may be calculated as a mood 280 for the context news source 240.

The code may further calculate 720 the context 285 for the digital message 255 and the method 700 ends. In one embodiment, the code creates a context histogram for each context represented by a context indicator 270. The context values 275 for each context represented by a context indicator 270 may be summed, and the context 285 with the largest some may be selected as the context 285 for the digital image 255.

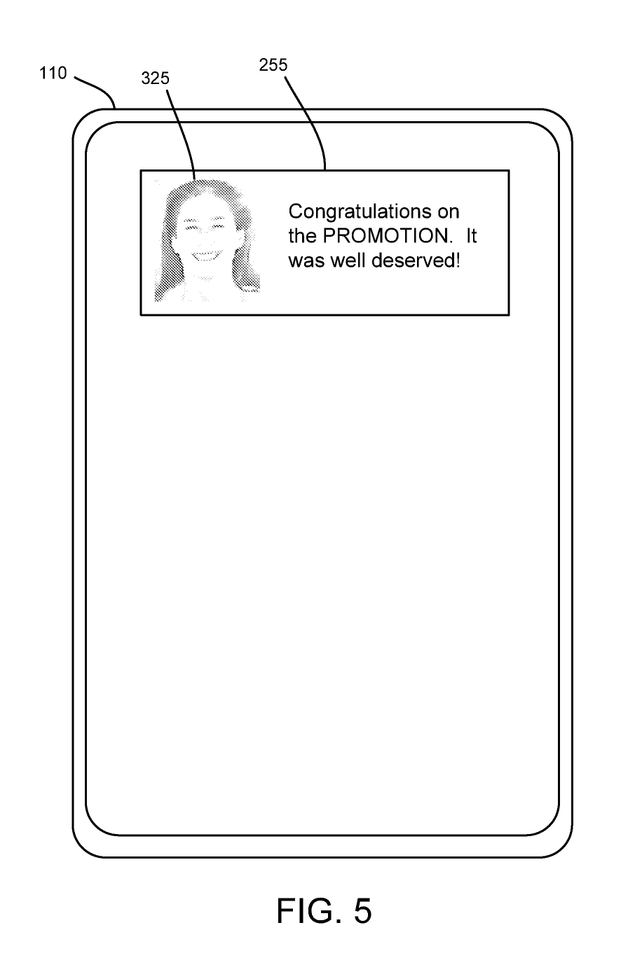

FIG. 5 is a front view drawing illustrating one embodiment of the target electronic device 110 displaying the digital message 255. In the depicted embodiment, a tablet target electronic device 110 displays the digital message 255. The mood 280 may be identified as positive because of the mood key word 205 “Congratulations” and/or the mood punctuation 210 exclamation mark, and an image 325 that corresponds to the positive mood 280 is associated with the digital message 255 by appending the image 325 as part of the digital message 255.

By identifying the mood 280 of a digital message 255, the embodiments may associate an image 325 such as a mood image 295 that corresponds to the mood 280 to the digital message 255. As a result, the image 325 is appropriate for the mood 280 of the digital message 255. Thus, if the mood 280 of the digital message 255 is upbeat, an upbeat image will be associated with the digital message 255. Conversely, if the mood 280 of the digital message 255 is sympathetic, and appropriately sympathetic image 325 will be associated with the digital message 255.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an electronic device comprising a processor and a memory that stores code executable by the processor, the code comprising:
code that identifies a mood of a digital message; and
code that associates an image that corresponds to the mood to the digital message.

2. The apparatus of claim 1, wherein the image is associated with the digital message by an association selected from the group consisting of appending the image to the digital message, appending a pointer to the image to the digital message, and designating the image as a message account image for a display time interval.

3. The apparatus of claim 1, wherein the mood is identified in response to a mood indicator selected from the group consisting of a mood key word, a mood punctuation, a mood capitalization, and an emoticon.

4. The apparatus of claim 1, wherein the mood is identified from a voice tone.

5. The apparatus of claim 1, wherein the image is selected in response to one of the mood and a context.

6. The apparatus of claim 5, wherein the context is identified in response to a context indicator selected from the group consisting of a context key word, a context location, and a context news source.

7. The apparatus of claim 5, wherein the image is selected in response to the context.

8. A method comprising:
identifying, by use of a processor, a mood of a digital message; and
associating an image that corresponds to the mood to the digital message.

9. The method of claim 8, wherein the image is associated with the digital message by an association selected from the group consisting of appending the image to the digital message, appending a pointer to the image to the digital message, and designating the image as a message account image for a display time interval.

10. The method of claim 8, wherein the mood is identified in response a mood indicator selected from the group consisting of a mood key word, a mood punctuation, a mood capitalization, and an emoticon.

11. The method of claim 8, wherein the mood is identified from a voice tone.

12. The method of claim 8, wherein the image is selected in response to one of the mood and a context.

13. The method of claim 12, wherein the context is identified in response to a context indicator selected from the group consisting of a context key word, a context location, and a context news source.

14. The method of claim 12, wherein the image is selected in response to the context.

15. A program product comprising a computer readable storage medium that stores code executable by a processor to perform:
identifying a mood of a digital message; and
associating an image that corresponds to the mood to the digital message.

16. The program product of claim 15, wherein the image is associated with the digital message by an association selected from the group consisting of appending the image to the digital message, appending a pointer to the image to the digital message, and designating the image as a message account image for a display time interval.

17. The program product of claim 15, wherein the mood is identified in response to a mood indicator selected from the group consisting of a mood key word, a mood punctuation, a mood capitalization, and an emoticon.

18. The program product of claim 15, wherein the mood is identified from a voice tone.

19. The program product of claim 15, wherein the image is selected in response to one of the mood and a context.

20. The program product of claim 19, wherein the context is identified in response to a context indicator selected from the group consisting of a context key word, a context location, and a context news source.
